(19) United States
(12) Patent Application Publication
(10) Pub. No.: US 2006/0129509 A1
(43) Pub. Date: Jun. 15, 2006

(54) Database schema

(75) Inventors: Guy Anthony Gaines, Fair Oaks, CA (US); Jason Patrick Walker, Roseville, CA (US)

Correspondence Address: Robert E. Krebs;Thelen Reid & Priest LLP, P.O. Box 640640, San Jose, CA, 95164-0640, US

(73) Assignee: Calpine Corporation, a Delaware Corporation

(21) Appl. No.: 11/009,288

(22) Filed: Dec. 9, 2004

(51) Int. Cl. G06F 17/30

(52) U.S. Cl. 707/1

(57) ABSTRACT

An unlimited number of sets may be persisted and interrelated, while each element of each set has an unlimited collection of properties or attributes, and each element of each set may also have an unlimited collection of transactions which themselves may have an unlimited collection of properties or attributes, by using three types of tables, control data tables, authentication data tables, and data tables, and providing a clear separation between them. Control data tables may define the schema and behavior, authentication data tables may be utilized in access control and security, and data tables may comprise the content of the databases.

### FIELD OF THE INVENTION

The present invention relates to database software. More particularly, the present invention relates to a schema for managing a database with improved performance.

### BACKGROUND OF THE INVENTION

Project management is the process of keeping track of all the different phases of complex activities over time. Project management software enables such activities to be broken into many separate sub-tasks, and then displays the way these tasks overlap in time, often using some standard model such as Gantt charts or Critical Path Analysis.

Project management is very complex, comprising a multitude of requirements for information management. These requirements range from estimating and budgeting processes to task management, planning, and scheduling. Additionally, there are various processes that need attention such as specifications, design, procurement, progress, quality, and deficiencies.

Currently, there are numerous vendors providing solutions for each of these needs, and a number of these vendors have created application suites that can be used to manage the majority of the pieces of information necessary for effective Project Management. However, these application suites are often the result of the aggregation of various disparate products into a single brand name. This phenomenon is driven primarily by economics, as the rush to get products to market frequently motivates vendors to buy existing pieces of the puzzle and weave them into their name brand. While this aggregating seems to meet the “to market” objective, the difficulties associated with merging tools with an assortment of design standards and approaches into a single name brand creates additional challenges. The most obvious of these challenges come in the form of efficiency and usability. Current Project Management applications have very complex interfaces that can bewilder users and are unmanageable at the technical level, especially when it comes to integrating with other products.

The management of data can be generally broken down into the following three broad categories:

(1) Set Management, which addresses those domains comprised of various elements that represent those objects that have been chosen to be represented and have data related to.

(2) Property Management, which addresses the characteristics or attributes used to describe the various elements of a set.

(3) Transaction Management, which addresses those recurrent events that are value and time sensitive in nature and occur against a member, or members, of a set.

Access to the data must be directed and controlled. In a conventional database modeling approach, an extensive study of the subject process or processes is conducted and documented in an accepted manner. Subsequently, design parameters and data structures are extracted, normalization processes are executed, and sets with like or common properties are identified. Tables and Indexes are then structured to accommodate the persistence of the set elements as well as their inherent properties. Relationships are then developed between the set elements and/or their properties, with additional tables created to maintain integrity of those relationships between like properties of the sets. Finally, an application is wrapped around all of this, allowing the users to interact with the data.

Throughout the course of this process, tables are invariably named in a manner that describes their component set. For example, if the table is used to store information about people, it might be named “tblPeople”. Similarly, columns are named in a manner describing their contents. Clearly this mnemonic naming of objects facilitates the categorization of data into various domains, enabling user interaction with the data.

As code is developed to allow interaction with the data, this mnemonic naming approach becomes inextricably embedded into the code. This has a few drawbacks. First, code tends to become “single purpose” as to the specific metadata that is being operated upon. Similar operations on two different metadata sets (tables or columns) will often require two completely separate code objects, each structured to operate on the naming of its particular set. Second, the approach seems to work well for processes that are static in nature, where there are few, if any, changes. However, attempts to reflect process changes are challenging and costly, requiring modifications to code as well as frequent modifications to the base data structures. Third, whenever a database is modified, testing and rollout can be very time consuming. Fourth, when multiple databases are integrated across multiple platforms, the prior art schema is heavily restricted.

The end result is that many businesses force their processes to fit within the constraints of existing applications, frequently resulting in inefficiencies for those business processes. What is needed is a viable and efficient solution for the management of Sets, Properties, and Transactions.

### BRIEF DESCRIPTION OF THE INVENTION

An unlimited number of sets may be persisted and interrelated, while each element of each set has an unlimited collection of properties or attributes, and each element of each set may also have an unlimited collection of transactions which themselves may have an unlimited collection of properties or attributes, by using three types of tables, control data tables, authentication data tables, and data tables, and providing a clear separation between them. Control data tables may define the schema and behavior, authentication data tables may be utilized in access control and security, and data tables may comprise the content of the databases.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a parent-child set type arrangement in a data_element table in accordance with an embodiment of the present invention.

FIG. 2 is a diagram illustrating a data_elements table in accordance with an embodiment of the present invention.

FIG. 3 is a diagram illustrating an organizational chart in accordance with an embodiment of the present invention.

FIG. 4 is a diagram illustrating a parent-child set type arrangement in a data_element table along with a ctl_element table in accordance with an embodiment of the present invention.

FIG. 5 is a diagram illustrating the content of a ctl_elements table in accordance with an embodiment of the present invention.

FIG. 6 is a diagram illustrating the content of a ctl_elements table after additional classes have been added in accordance with an embodiment of the present invention.

FIG. 7 is a diagram illustrating a data_elements table with newly added records in accordance with an embodiment of the present invention.

FIG. 8 is a diagram illustrating an organizational chart after the addition of records in accordance with an embodiment of the present invention.

FIG. 9 is a diagram illustrating an example of attribute tables and associated support and control tables in accordance with an embodiment of the present invention.

FIG. 10 is a diagram illustrating an example of a control attribute table loaded with desired attributes in accordance with an embodiment of the present invention.

FIG. 11 is a diagram illustrating an example of a control class attributes links table in accordance with an embodiment of the present invention.

FIG. 12 is a diagram illustrating an organizational chart showing loaded attributes in accordance with an embodiment of the present invention.

FIG. 13 is a diagram illustrating the storage of txt attributes in accordance with an embodiment of the present invention.

FIG. 14 is a diagram illustrating the storage of num attributes in accordance with an embodiment of the present invention.

FIG. 15 is a diagram illustrating a ctl_elements table with added classes in accordance with an embodiment of the present invention.

FIG. 16 is a diagram illustrating actual data added to a data elements table in accordance with an embodiment of the present invention.

FIG. 17 is a diagram illustrating attributes added to a data attribute dnx table in accordance with an embodiment of the present invention.

FIG. 18 is a diagram illustrating a data_xact table in accordance with an embodiment of the present invention.

FIG. 19 is a diagram illustrating actual cost data added into a data transactions table in accordance with an embodiment of the present invention.

FIG. 20 is a diagram illustrating records that may be added to the ctl_elements table in accordance with an embodiment of the present invention.

FIG. 21 is a diagram illustrating a data elements table in accordance with an embodiment of the present invention.

FIG. 22 is a diagram illustrating the data elements table of FIG. 21 with an additional record representing an association between elements in accordance with an embodiment of the present invention.

FIG. 23 is a flow diagram illustrating a method for adding data to a database in accordance with an embodiment of the present invention.

FIG. 24 is a block diagram illustrating an apparatus for adding data to a database in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention allows an unlimited number of sets to be persisted and interrelated, while each element of each set has an unlimited collection of properties or attributes, and each element of each set may also have an unlimited collection of transactions which themselves may have an unlimited collection of properties or attributes. This may be accomplished using three types of tables, control data tables, authentication data tables, and data tables, and providing a clear separation between them. Control data tables may define the schema and behavior, authentication data tables may be utilized in access control and security, and data tables may comprise the content of the databases.

In an embodiment of the present invention, three similar structures may be provided that each allow for the persistence of sets, properties, and transactions. As a naming convention, prefixes may be applied to table names, where xxxxxxxx is the table name, in the following fashion:

| | |
|---|---|
| Control | ctl_xxxxxxxx |
| Authentication | auth_xxxxxxxx |
| Data | data_xxxxxxxx |

Additionally, for the sake of brevity, a similar notation may be used to address table names from all three sets. For example zzzz_elements may refer to ctl_elements, auth_elements, and data_elements.

Sets are domains comprised of various elements, representing those objects to which data should be related. Sets may be thought of as elements, or in more conventional terms, rows or records. The present invention allows for an unlimited number of primary data structures, with each set having a hierarchical Parent-Child structure. Additionally, each element member of each set can have an unlimited number of relationships with members of any set, including its own.

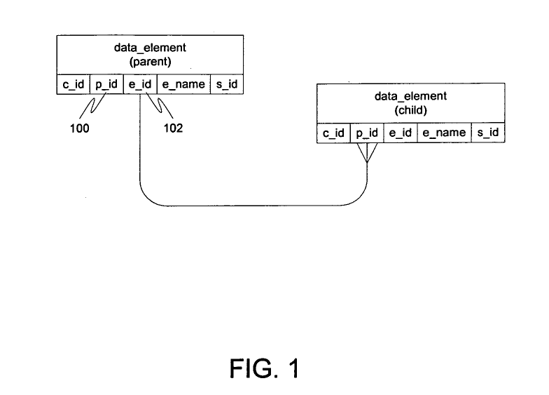

FIG. 1 is a diagram illustrating a parent-child set type arrangement in a data_element table in accordance with an embodiment of the present invention. Here, each parent (p_id) 100 is allowed multiple children (e_id) 102, and that the parent 100 for a given child must exist in the data_elements table as an element (e_id).

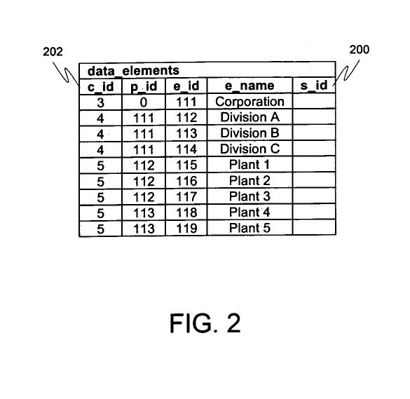

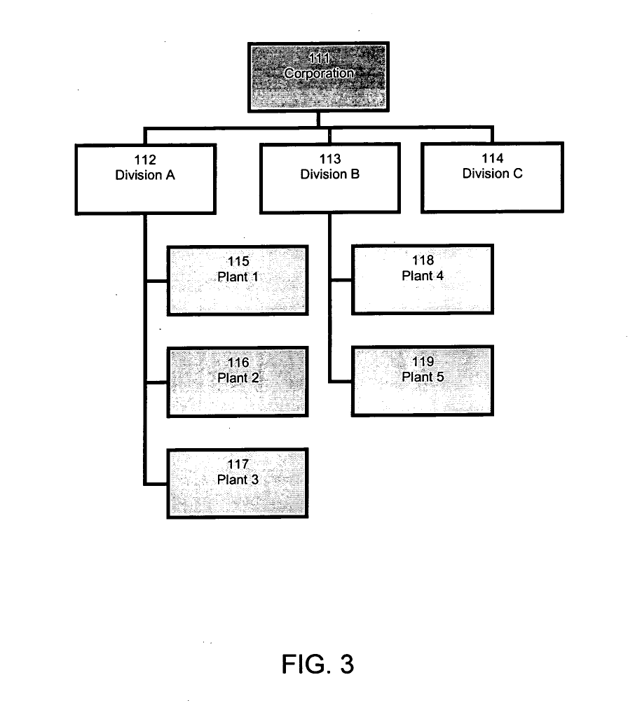

As an example, the p_id value 0 may be reserved as the root. However, any unique character may be used. FIG. 2 is a diagram illustrating a data_elements table in accordance with an embodiment of the present invention. FIG. 3 is a diagram illustrating an organizational chart in accordance with an embodiment of the present invention. Populating the data_elements table as shown in FIG. 2 would persist the necessary structure for the organizational chart in FIG. 3. The s_id column 200 is a utility column introduced to simplify programming, hence the absence of data in that column. Additionally, the c_id value 202 may change for each type of element, or level in the organizational chart depicted in FIG. 3.

The implementation of c_id allows for the persistence of multiple separate primary data structures as well as multiple associative data structures. This effectively allows for the creation of separate instances of the zzzz_elements tables. Additionally, c_id may also be leveraged to assign a set of attributes to those elements of a particular class, which will be described in more detail later in this document. To support this, the ctl_elements table may be introduced.

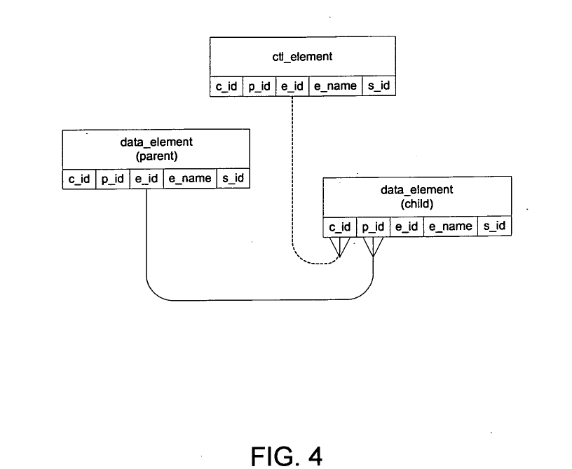

FIG. 4 is a diagram illustrating a parent-child set type arrangement in a data_element table along with a ctl_element table in accordance with an embodiment of the present invention. Within the ctl_elements table, positive values of c_id may be used to differentiate between class types for those elements in the ctl_elements table. Negative c_id values may be reserved to differentiate entity types for those elements present in the zzzz_elements table. −1 may define a record of type Class for use with zzzz_elements. −2 may define a record of type Class for use with zzzz_xact.

−3 may define a record of type Association for use with zzzz_elements.

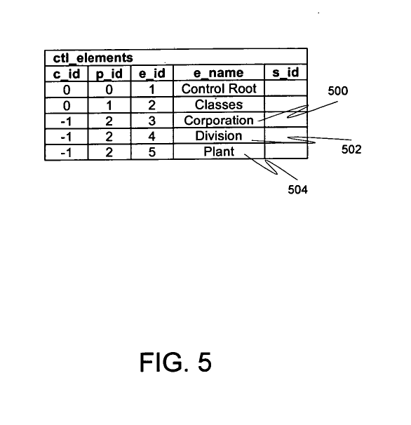

FIG. 5 is a diagram illustrating the content of a ctl_elements table in accordance with an embodiment of the present invention. Elements bearing c_id of −1 establish classes for corporation 500, division 502, and plant 504.

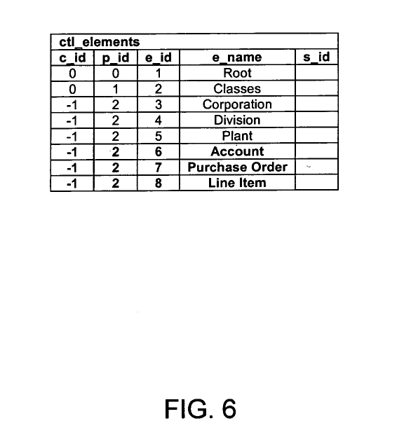

In order to add another primary data structure to data_elements, the additional classes may first be added to the ctl_elements table. FIG. 6 is a diagram illustrating the content of a ctl_elements table after additional classes have been added in accordance with an embodiment of the present invention. Then, c_id may be set to a value of −1 to indicate that the record is of type Class for use with zzzz_elements.

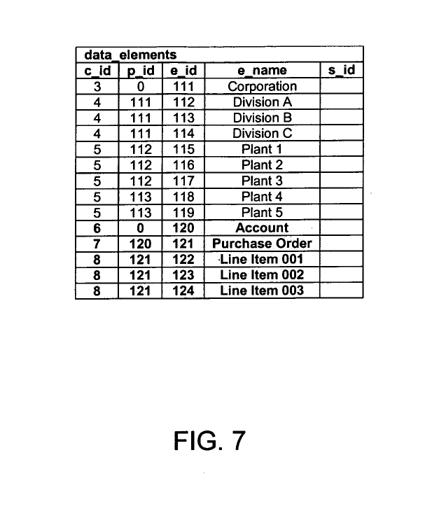

After adding records to the ctl_elements tables, records can then be added to the data_elements table, representing the new primary data structure. FIG. 7 is a diagram illustrating a data_elements table with newly added records in accordance with an embodiment of the present invention. Primary data structures can be persisted as well as associated data structures. The difference between the two is that each element belongs to its own primary data structure domain, while it is possible for that same element to be a part of several associative data structure domains.

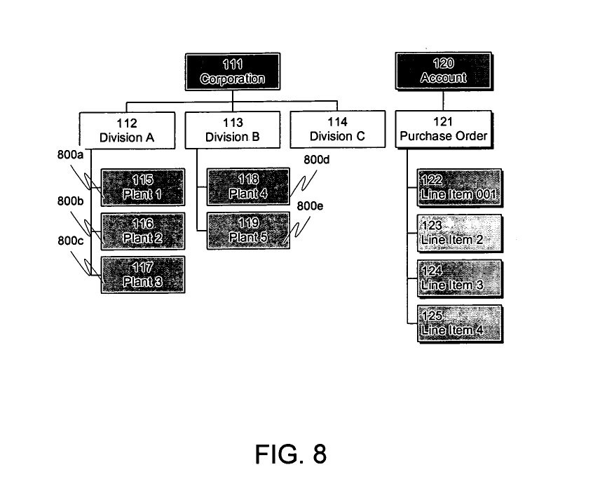

FIG. 8 is a diagram illustrating an organizational chart after the addition of records in accordance with an embodiment of the present invention. Here, five plants 800a, 800b, 800c, 800d, 800e of a corporation 802 are represented, and separate structure 804 represents a purchase order.

Turning to properties, properties are those characteristics or attributes that can be used to describe the various elements of a set. These may be thought of as attributes or columns. The present invention allows for an unlimited number of attributes that can be made available to any element. In conventional terms, these attributes are synonymous with the metadata tags used to name columns in tables. For this implementation, some new tables may be introduced into the schema. These include ctl_attr, which serves as a collection of all available attributes, and data_e_attr_xxx, where xxx represents the type of data persisted. The available options may be anx, cnx, dnx, which represent lookups to e_id from auth_elements, ctl_elements, or data_elements, respectively. For those attributes that are not lookups, the available options are date/time(dtm), obj, num and txt, which store data for the suggested formats.

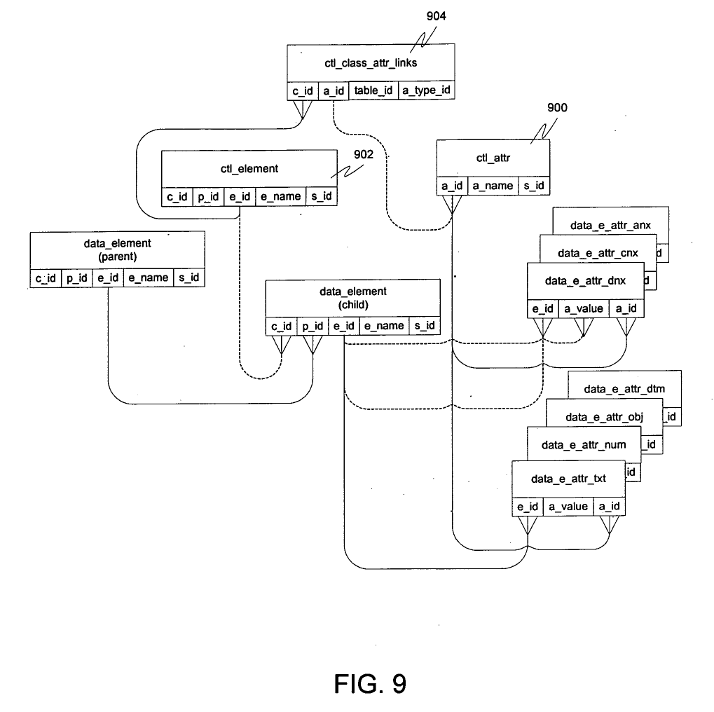

FIG. 9 is a diagram illustrating an example of attribute tables and associated support and control tables in accordance with an embodiment of the present invention. The two sets of tables have been separated to demonstrate the different relationships. In this schema, the metadata column name is persisted in the ctl_attr table 900, while the actual attribute value is persisted in the appropriate data_e_attr_xxx tables. The collection of attributes available for a given element in ctl_element (class) 902 is persisted in ctl_class_attr_links 904.

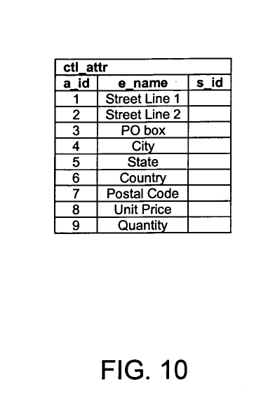

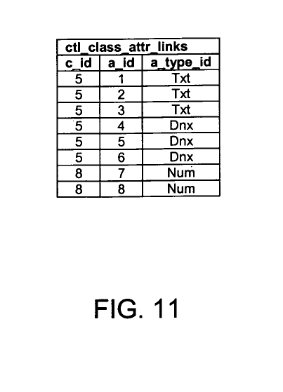

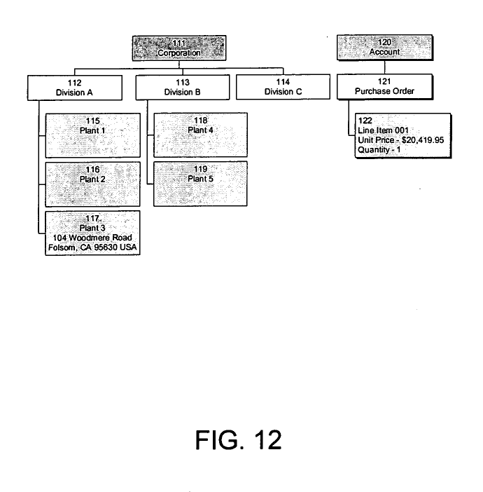

For example, if each of the plants should have an address, and the Purchase Order Line Item a Unit Price and Quantity, then first the attributes should be made available to the appropriate classes. This may involve loading ctl_attr with the desired attributes, as depicted in FIG. 10. Next, ctl_class_attr_links may be loaded to enable the appropriate attributes for the appropriate classes, as depicted in FIG. 11. There are 3 different a_type_id values: txt, dnx, and num. This is actually a simplification as the actual stored values may be numeric keys that represent txt, dnx, and num. This means that the actual attribute values may be stored in 3 different tables. In this example, attributes may be loaded to persist data as shown in FIG. 12.

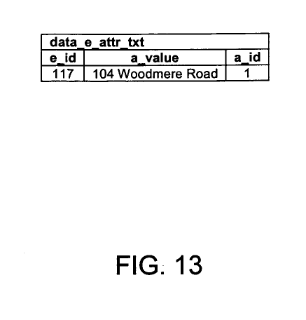

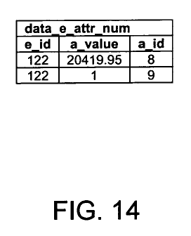

The storage of the txt and num attributes is straightforward and may be represented by FIG. 13 and FIG. 14, respectively. The storage of the dnx attributes is a bit more complex, as the stored value in the dnx is really a pointer to e_id in data_elements. The stored value for the state attribute (a_id=5) is really a pointer to the e_id record.

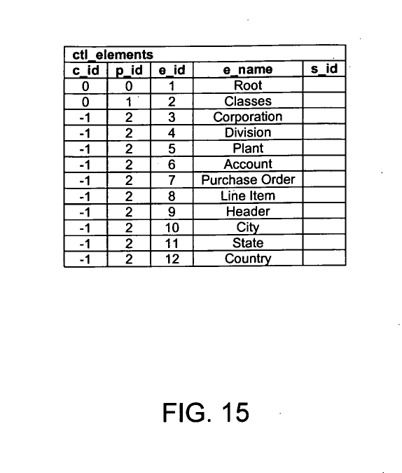

In order to facilitate this, some records may be added to the ctl_elements table for the classes of dnx records. This effectively allows the system to create separate instances of the data_elements table, one for each dnx class. FIG. 15 is a diagram illustrating a ctl_elements table with added classes in accordance with an embodiment of the present invention. Here, e_id=9, for Header, has been added to serve as an organizational branch used to organize like classes.

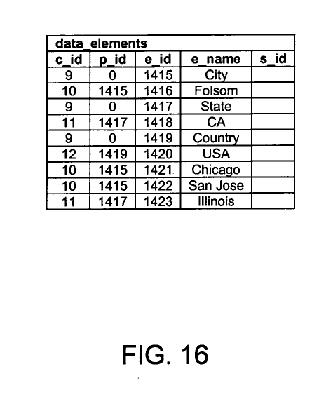

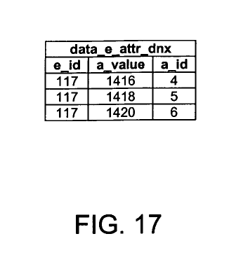

Now that the classes have been created, the actual data may be added to the data_elements table and attributes (pointers) may be added to the data_e_attr_dnx table. This is depicted in FIGS. 16 and 17, respectively.

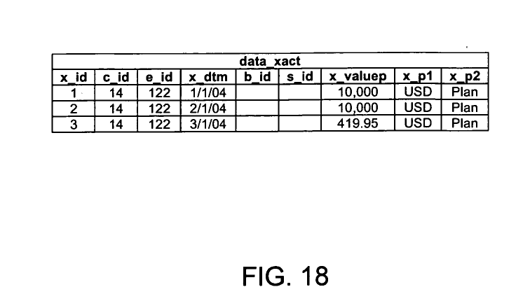

Turning to transactions, transactions are those recurring events that are value and time sensitive in nature which occur against a member, or members of a set. Transactions can possess properties. The present invention allows for an unlimited number of transactions having an unlimited number of types of transmissions. Transactions have available to them the same property mechanism that has been demonstrated for elements. A transaction may be viewed as a child of an element, with the properties of the transaction describing the nature of the transaction. Continuing with the Purchase Order example above, the payments for the purchase order may occur over time. FIG. 18 is a diagram illustrating a data_xact table in accordance with an embodiment of the present invention. The payments may be recorded in the data_xact table 1800.

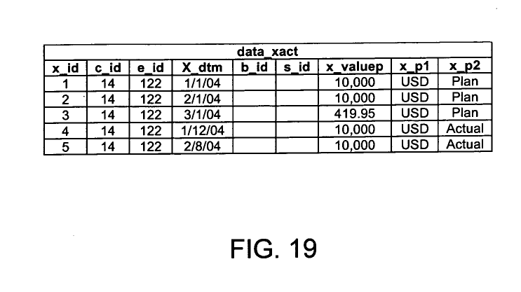

For simplicity, text has been loaded in x_p1, x_p2, which in reality will be dnx types that are pointers to e_id in data_elements. Actual cost data can be easily added into data_xact, as depicted in FIG. 19.

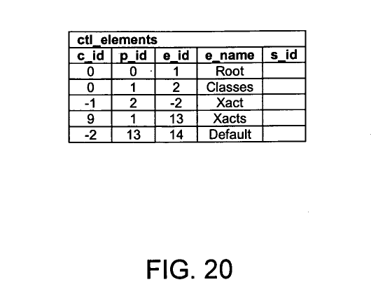

Transactions also have c_id that is used to effectively containerize the available property set for a given type of transaction. Also, b_id refers to a processing batch that can be used to associate transactions with batch processing events. FIG. 20 is a diagram illustrating records that may be added to the cnt_elements table in accordance with an embodiment of the present invention. Here, a record may be created for the default type of transaction.

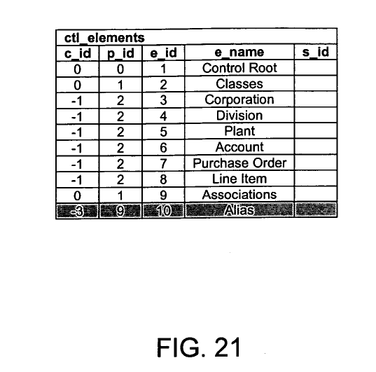

Turning to sets, sets are associative data structure domains that can be extremely useful and efficient for presenting data from several different contexts. For example, one may want to present the 121 Purchase Order record as a child of the 117 Plant record. This can simply be added as an association between the element 117 and the element 121, as depicted in FIG. 21

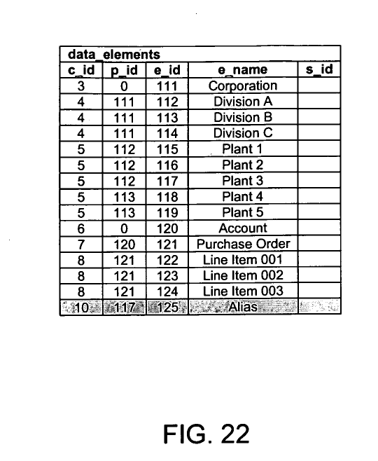

To accomplish this, a record may be added to ctl_elements that may be used to classify the record in data_elements as an association. One of the primary types of associations that is used is an alias. An alias allows the mixture of data between primary data structure domains, effectively making the data from the primary domain available in the associative domain. Now a record can be added to the data_elements table that represents the association between 117 Plant and 121 Purchase Order, as depicted in FIG. 22

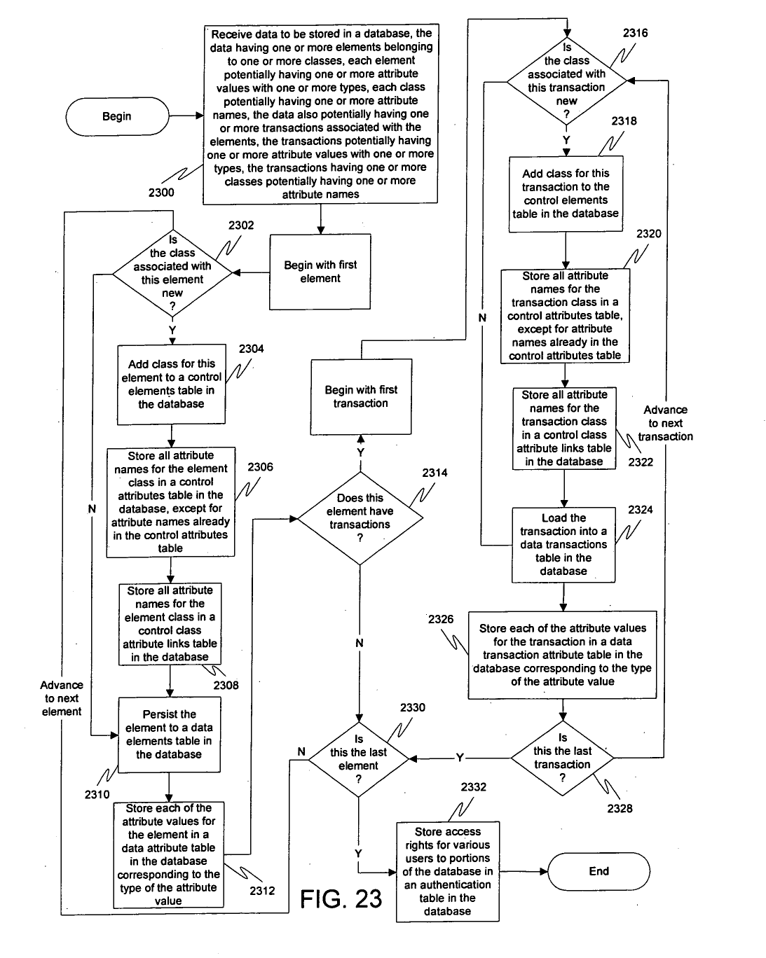

This record may depend on a dnx attribute to point at the source element, and based on the class of association, various sets of business rules can be applied to the data engine to show children or not, to carry source attributes or not, etc. The organizational chart in FIG. 23 depicts a situation where the association has been designated to include all children of the source element.

FIG. 23 is a flow diagram illustrating a method for adding data to a database in accordance with an embodiment of the present invention. Each act in this method may be performed in software, hardware, or any combination thereof. At 2300, data to be stored in the database may be received, the data having one or more elements belonging to one or more classes, each element potentially having one or more attribute values with one or more types, each class potentially having one or more attribute names, the data also potentially having one or more transactions associated with the elements, the transactions potentially having one or more attribute values with one or more types, the transactions having one or more classes potentially having one or more attribute names. 2302-2330 refer to acts performed within a loop. The loop advances through the elements in the data, beginning with the first element. At 2302, it may be determined if the class associated with this element is new. If so, then at 2304, the class for this element may be added to a control elements table in the database. Then at 2306, all attribute names for the element class may be stored in a control attributes table in the database, except for attribute names already in the control attributes table. At 2308, all attribute names for the element class may be stored in a control class attribute links table in the database. 2304-2306 need only be performed if the class associated with this element is new.

At 2310, the element may be persisted to a data elements table in the database. At 2312, each of the attribute values for the element may be stored in a data attribute table in the database corresponding to the type of the attribute value. At 2314, it then may be determined if the element has transactions. If so, then 2316-2328 refer to acts performed within a loop. The loop advances through the transactions in the element, beginning with the first transaction. At 2316, it may be determined if the class associated with this transaction is new. If so, then at 2318, the class for this transaction may be added to the control elements table in the database. At 2320, all attribute names for the transaction class may be stored in a control attributes table, except for attribute names already in the control attributes table. At 2322, all attribute names for the transaction class may be stored in a control class attribute links table in the database. 2318-2322 need only be performed if the class associated with this transaction is new.

At 2324, the transaction may be loaded into a data transactions table in the database. At 2326, each of the attribute values for the transaction may be stored in a data transaction attribute table in the database corresponding to the type of the attribute value. At 2328, it may be determined if this is the last transaction for the element. If not, then the process may loop back to 2316, advancing to the next transaction for the element. If so, however, then at 2330, it may be determined if this is the last element in the data. If not, then the process may loop back to 2302, advancing to the next element in the data. If so, however, then at 2332, access rights for various users to portions of the database may be stored in an authentication table in the database. It should be noted that it may be necessary to prevent users from accessing the data in these portions of the database until access rights are established, lest newly loaded data be left available to unwanted access.

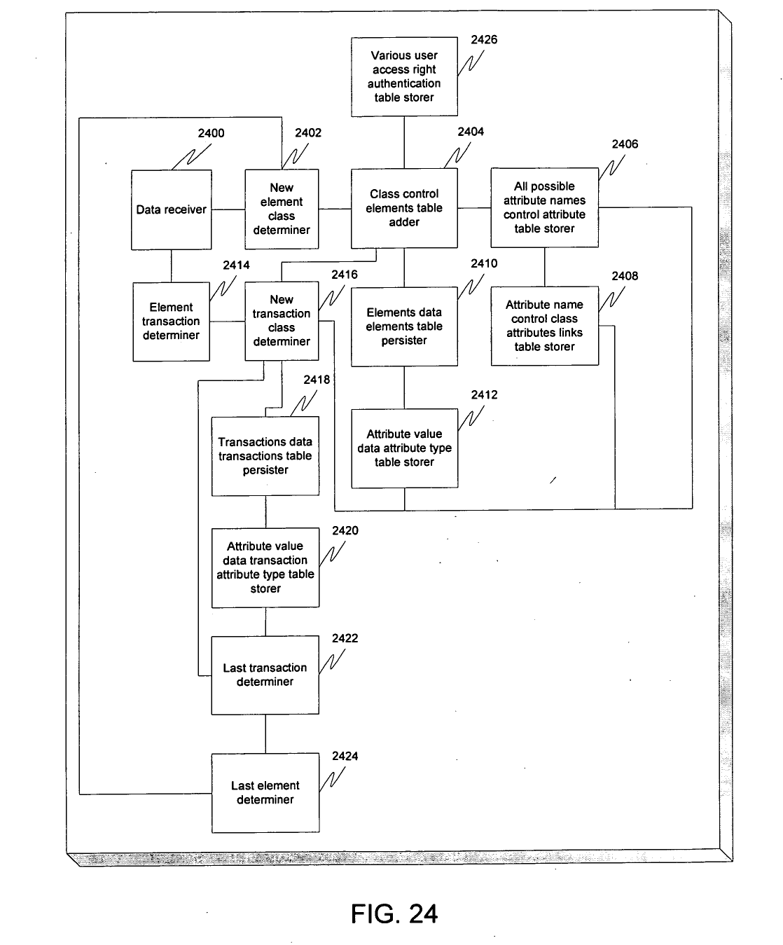

FIG. 24 is a block diagram illustrating an apparatus adding data to a database in accordance with an embodiment of the present invention. Each element in this apparatus may be embodied in software, hardware, or any combination thereof. A data receiver 2400 may receive data to be stored in the database, the data having one or more elements belonging to one or more classes, each element potentially having one or more attribute values with one or more types, each class potentially having one or more attribute names, the data also potentially having one or more transactions associated with the elements, the transactions potentially having one or more attribute values with one or more types, the transactions having one or more classes potentially having one or more attribute names. Acts may then be performed within a loop. The loop advances through the elements in the data, beginning with the first element. A new element class determiner 2402 coupled to the data receiver 2400 may determine if the class associated with this element is new. If so, then a class control elements table adder 2404 coupled to the new element class determiner 2402 may add the class for this element a control elements table in the database. Then an all possible attribute names control attribute table storer 2406 coupled to the class control elements table adder 2404 may store all attribute names for the element class in a control attributes table in the database, except for attribute names already in the control attributes table. An attribute name control class attribute links table storer 2408 coupled to the all possible attribute names control attribute table storer 2406 may store all attribute names for the element class in a control class attribute links table in the database.

An elements data elements table persister 2410 coupled to the class control elements table adder 2404 and to the attribute name control class attribute links table storer 2408 may persist the element to a data elements table in the database. An attribute value data attribute type table storer 2412 coupled to the elements data elements table persister 2410 may store each of the attribute values for the element in a data attribute table in the database corresponding to the type of the attribute value.

An element transaction determiner 2414 coupled to the data receiver 2400 may determine if the element has transactions. If so, then acts are performed within a loop. The loop advances through the transactions in the element, beginning with the first transaction. A new transaction class determiner 2416 coupled to the element transaction determiner 2414 may determine if the class associated with this transaction is new. If so, then the class control elements table adder 2404 coupled to the new transaction class determiner 2416 may add the class for this transaction to the control elements table in the database. The all possible attribute names control attribute table storer 2406 may then store all attribute names for the transaction class in a control attributes table, except for attribute names already in the control attributes table. The attribute name control class attribute links table storer 2408 may then store all attribute names for the transaction class in a control class attribute links table in the database.

A transactions data transactions table persister 2418 coupled to the new transaction class determiner 2416 may load the transaction into a data transactions table in the database. An attribute value data transaction attribute type table storer 2420 coupled to the transactions data transactions table persister 2418 may then store each of the attribute values for the transaction in a data transaction attribute table in the database corresponding to the type of the attribute value. A last transaction determiner 2422 coupled to the attribute value data transaction attribute type table storer 2420 may determine if this is the last transaction for the element. If not, then the process may proceed back to determining if the transaction class is new, advancing to the next transaction for the element. If so, however, then a last element determiner 2424 coupled to the last transaction determiner 2422 may determine if this is the last element in the data. If not, then the process may loop back to determining if the element class is new, advancing to the next element in the data. If so, however, then a various user access right authentication table storer 2426 coupled to the new element class determiner 2402 may store access rights for various users to portions of the database in an authentication table in the database. It should be noted that it may be necessary to prevent users from accessing the data in these portions of the database until access rights are established, lest newly loaded data be left available to unwanted access.

The present invention allows the supporting database code to be reused, in that a similar object may be used in various places within the same application. It also allows the code to be portable, as it can be easily utilized by other platforms. Furthermore, the present invention provides a schema that is easily compatible with distributed systems. Additionally, the cost of implementation and the storage size of the database are both dramatically reduced. The present invention also allows database modification to occur at a much quicker rate of speed than prior art solutions.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for adding data to a database, the data having one or more elements belonging to one or more classes, the elements having one or more attribute values and the classes having one or more attribute names, each attribute value having a type, the method comprising:
adding each of the one or more classes to a control elements table in said database, if said class is not already stored in said control elements table;
persisting the elements to a data elements table in said database; and
storing each of the attribute values in a data attribute table corresponding to the type of the attribute value, wherein said data attribute table is in said database.

2. The method of claim 1, further comprising:
storing all possible attribute names in a control attribute table in said database, except for attribute names already in the control attributes table.

3. The method of claim 1, wherein said control elements table includes a parent identification field for each element in said control elements table.

4. The method of claim 3, wherein said elements belong to one or more sets, each of said sets having a root element.

5. The method of claim 4, wherein said adding includes inserting a unique character into said parent identification field for each root element.

6. The method of claim 1, wherein said types of attributes include lookups to said control elements, data elements tables.

7. The method of claim 1, wherein said types of attributes include date/time, objects, numbers, and text.

8. The method of claim 1, further comprising:
storing all attribute names for a given class in a control class attribute links table associated with said given class in said database.

9. The method of claim 6, wherein said storing includes storing a pointer to the control elements or data elements table.

10. The method of claim 1, wherein one of the one or more classes is an association.

11. The method of claim 1, wherein said data further has one or more transactions associated with the elements, each transaction having one or more attributes values with one or more types, each transaction class having one or more attribute names, the method further comprising:
adding each of the one or more transaction classes to said control elements table in said database, if said transaction class is not already stored in said control elements table;
persisting the transactions to a data transactions table in said database; and
storing each of the transaction attribute values in a data transaction attribute table corresponding to the type of the attribute value, wherein said data transaction attribute table is in said database.

12. The method of claim 11, further comprising:
storing all possible attribute names for the transaction classes in a control attribute table in said database, except for attribute names already in the control attributes table.

13. The method of claim 11, further comprising:
storing all attribute names for a given transaction class in a control class attribute links table associated with said given transaction class in said database.

14. The method of claim 1, further comprising storing access rights for various users to portions of said database in an authentication table in said database.

15. An apparatus for adding data to a database, the data having one or more elements belonging to one or more classes, the elements having one or more attribute values and the classes having one or more attribute names, each attribute value having a type, the apparatus comprising:
a class control elements table adder;
an attribute value data attribute type table storer coupled to said class control elements table adder; and
an elements data elements table persister coupled to said attribute value data attribute type table storer.

16. The apparatus of claim 15, further comprising:
an all possible attribute names control attribute table storer coupled to said attribute value data attribute type table storer.

17. The apparatus of claim 15, further comprising:
an attribute name control class attribute links table storer coupled to said elements data elements table persister.

18. The apparatus of claim 15, wherein said data further has one or more transactions associated with the elements, each transaction having one or more attribute values with one or more types, each transaction class having one or more attribute names, the apparatus further comprising:
an transactions data transactions table persister; and
wherein said attribute value data attribute type table storer is coupled to said elements data elements table persister.

19. The apparatus of claim 15, further comprising:
a various user access right authentication table storer coupled to said class control elements table adder.

20. An apparatus for adding data to a database, the data having one or more elements belonging to one or more classes, the elements having one or more attribute values and the classes having one or more attribute names, each attribute value having a type, the apparatus comprising:
means for adding each of the one or more classes to a control elements table in said database, if said class is not already stored in said control elements table;
means for persisting the elements to a data elements table in said database; and
means for storing each of the attribute values in a data attribute table corresponding to the type of the attribute value, wherein said data attribute table is in said database.

21. The apparatus of claim 20, further comprising:
means for storing all possible attribute names in a control attribute table in said database, except for attribute names already in the control attributes table.

22. The apparatus of claim 20, wherein said control elements table includes a parent identification field for each element in said control elements table.

23. The apparatus of claim 22, wherein said elements belong to one or more sets, each of said sets having a root element.

24. The apparatus of claim 23, wherein said means for adding includes means for inserting a unique character into said parent identification field for each root element.

25. The apparatus of claim 20, wherein said types of attributes include lookups to said control elements, data elements tables.

26. The apparatus of claim 20, wherein said types of attributes include date/time, objects, numbers, and text.

27. The apparatus of claim 20, further comprising:
means for storing all attribute names for a given class in a control class attribute links table associated with said given class in said database.

28. The apparatus of claim 25, wherein said means for storing includes means for storing a pointer to the control elements or data elements table.

29. The apparatus of claim 20, wherein one of the one or more classes is an association.

30. The apparatus of claim 20, wherein said data further has one or more transactions associated with the elements, each transaction having one or more attributes values with one or more types, each transaction class having one or more attribute names, the apparatus further comprising:
means for adding each of the one or more transaction classes to said control elements table in said database, if said transaction class is not already stored in said control elements table;
means for persisting the transactions to a data transactions table in said database; and
means for storing each of the transaction attribute values in a data transaction attribute table corresponding to the type of the attribute value, wherein said data transaction attribute table is in said database.

31. The apparatus of claim 30, further comprising:
means for storing all possible attribute names for the transaction classes in a control attribute table in said database, except for attribute names already in the control attributes table.

32. The apparatus of claim 30, further comprising:
means for storing all attribute names for a given transaction class in a control class attribute links table associated with said given transaction class in said database.

33. The apparatus of claim 20, further comprising means for storing access rights for various users to portions of said database in an authentication table in said database.

34. A program storage device readable by a machine, tangibly embodying a program of instructions executable by the machine to perform a method for adding data to a database, the data having one or more elements belonging to one or more classes, one or more attributes having one or more types, and one or more transactions associated with said elements and said attributes, adding data to a database, the data having one or more elements belonging to one or more classes, the elements having one or more attribute values and the classes having one or more attribute names, each attribute value having a type, the method comprising:
adding each of the one or more classes to a control elements table in said database, if said class is not already stored in said control elements table;
persisting the elements to a data elements table in said database; and
storing each of the attribute values in a data attribute table corresponding to the type of the attribute value, wherein said data attribute table is in said database.
